(19) United States
(12) Patent Application Publication
(10) Pub. No.: US 2005/0058973 A1
(43) Pub. Date: Mar. 17, 2005

(54) Method and system for providing instructions for installation of stereo components

(76) Inventor: Mervin A. Dayan, Oakhurst, NJ (US)

Correspondence Address: Richard C. Weinblatt;Wolf, Block, Schorr and Solis-Cohen LLP, 22 Floor, 1650 Arch Street, Philadelphia, PA, 19103-2097, US

(21) Appl. No.: 10/914,249

(22) Filed: Aug. 9, 2004

Related U.S. Application Data
(60) Provisional application No. 60/493,240, filed on Aug. 7, 2003.

(51) Int. Cl. G06F 9/44

(52) U.S. Cl. 434/219

(57) ABSTRACT

A method of providing instructions for installing audio or electrical components or products comprises utilizing textual and graphical representations. A system for installing audio or electrical components or products comprises an instruction sheet or manual containing textual and graphical instructions. The textual and graphical instructions are presented in a clear and concise format so that a user can readily comprehend and understand the instructions.

### CROSS-REFERENCE TO RELATED APPLICATION

This application claims the benefit of U.S. Provisional Application No. 60/493,240, filed Aug. 7, 2003, the entire disclosure of which is incorporated herein by reference. This claim is being made within one year of the filing date of the provisional patent application because Aug. 7, 2004 was a Saturday.

### FIELD OF THE INVENTION

The present invention is directed to instructions for installation of home, mobile, and automobile stereo or electrical equipment. More particularly, the present invention comprises a method and system for providing textual and graphical instructions for installation of stereo or electrical components.

### BACKGROUND

Many stereo and electrical components require assembly and/or installation for use in the home or in an automobile. Generally, components are sold with directions on assembly and/or installation used by both professionals and nonprofessionals. These directions are usually in the form of written instruction manuals which are largely textual, comprising many pages of instructions. It is often laborious and difficult to follow these textual instructions which present obstacles to proper installation. Problems with installation can lead to frequent returns of stereo components at a loss to the retailer and manufacturer.

### SUMMARY

In accordance with one aspect of the present invention, a method of providing instructions for installing audio or electrical components or products comprises utilizing textual and graphical representations. In accordance with another aspect of the present invention, a system for installing audio components or products comprises an instruction sheet or manual containing textual and graphical instructions. The textual and graphical instructions are presented in a clear and concise format so that a user can readily comprehend and understand the instructions.

It is to be understood that the foregoing general description and the detailed description are exemplary, but not restrictive of the invention.

### BRIEF DESCRIPTION OF FIGURES

In the drawings, which are discussed below, one or more preferred embodiments are illustrated. It is understood that the invention is not limited to the preferred embodiments depicted in the drawings herein, but rather it is defined by the claims appended hereto and equivalent structures.

FIG. 1 is one embodiment of the present invention.

FIG. 2 is a second embodiment of the present invention.

### DETAILED DESCRIPTION

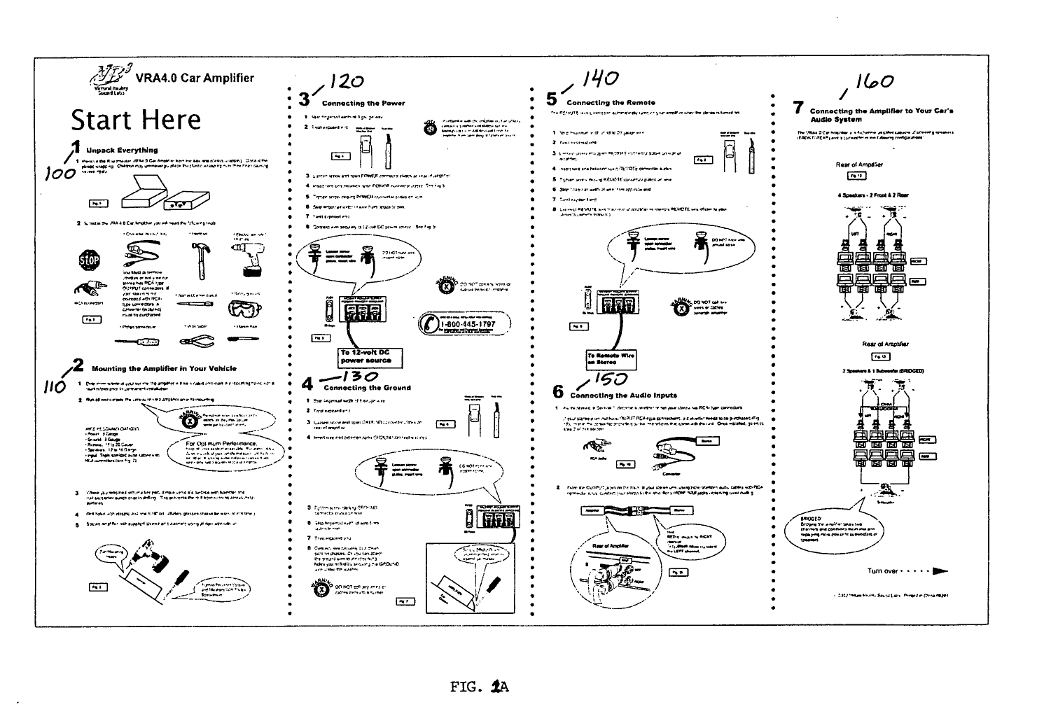

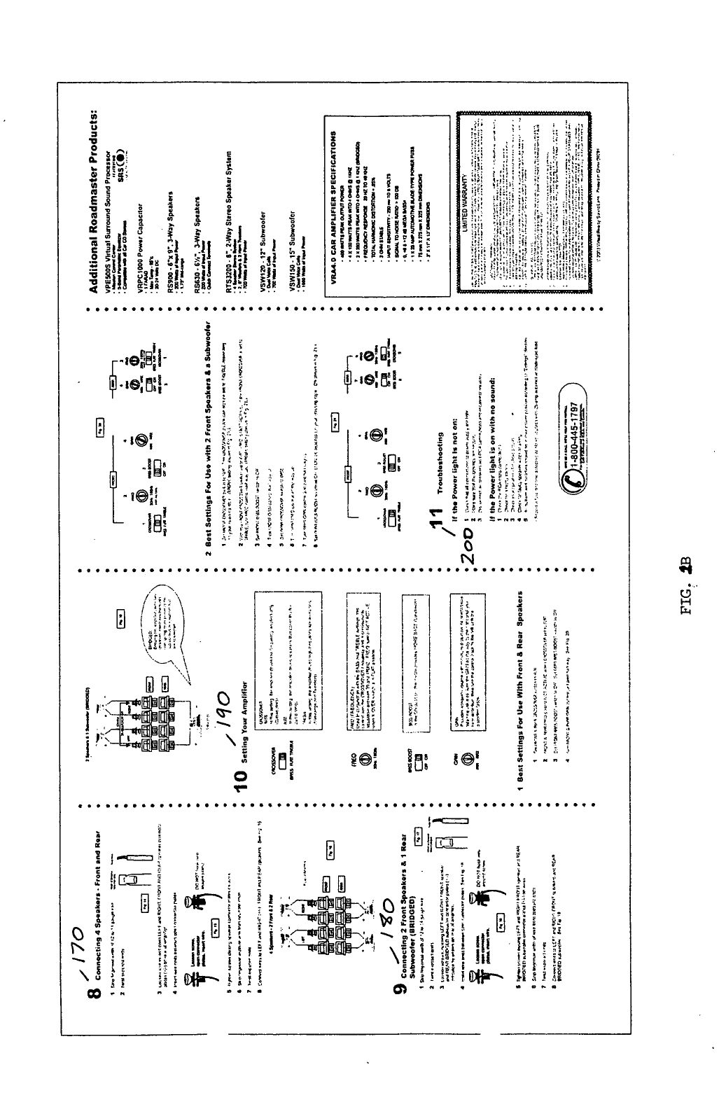

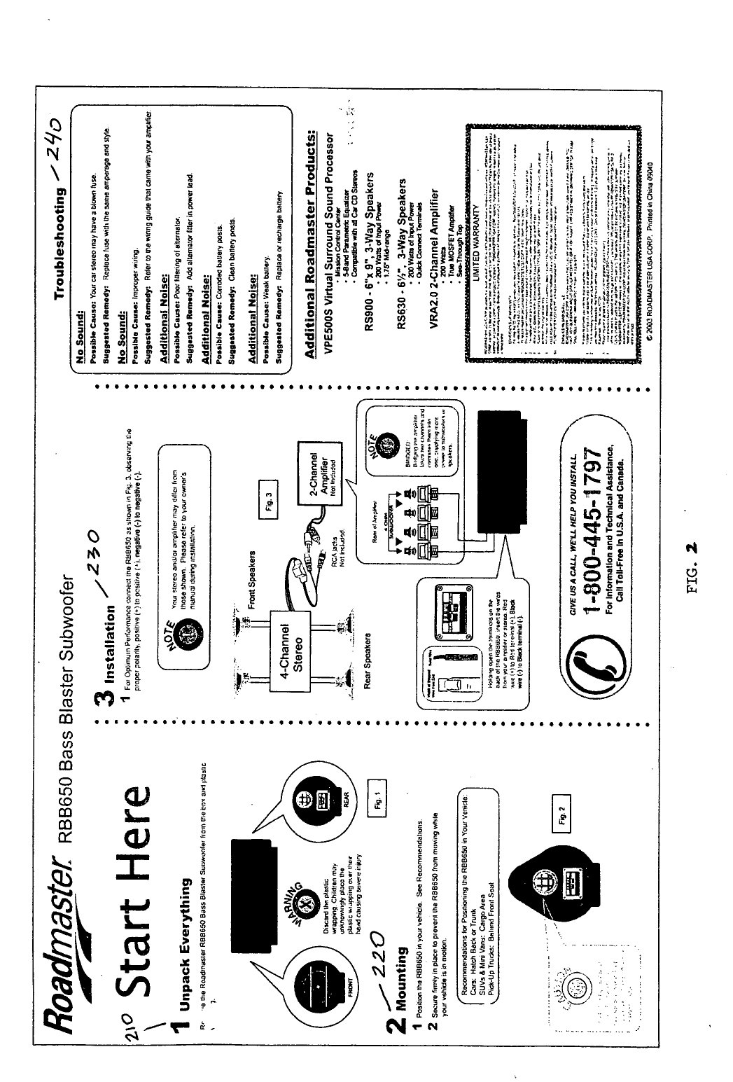

The present invention is directed to a textual and graphical method and system for providing instructions on installation of stereo or electrical components or products in a home, automobile or mobile units. In the method and system of the present invention, instructions are provided in a schematic format, use fewer pages and use graphical depictions of parts and tools required for installation. In addition, the installation steps are laid out clearly in sequence. The steps may be numbered steps and graphics depicting the assembly of parts and the making of connections may be present. FIGS. 1 and 2 depict exemplary methods and systems for instructing on installation with textual and graphical components. Alternatively, the steps may not be numbered and instead, either arrows or like signals may be used or the installation steps are located in a logical order so that a user will readily understand the sequence of steps.

Use of the method and system permits users to look at a graphical image and locate the actual component depicted in the image. The user will be able to hold the component and then attach it to the necessary object by referring to the graphic and the accompanying text. This method and system results in installation being easier and faster than when using typical installation guides because users do not have to solely rely on text to determine which component the text refers. Consequently, the present invention improves the installation process for professionals and nonprofessionals and results in fewer returns of stereo or electrical components (based on inability to install).

In one embodiment, the method and system comprise numbered steps, headings for each step, markings of each tool and part used, and graphical depictions or pictures of tools and parts used, and how the tools and parts are manipulated.

In one embodiment, shown in FIG. 1, the method and system utilize instructions for installing a car amplifier laid out graphically and textually in ten steps. These steps include: (1) unpacking the product's contents and laying out necessary tools 100; (2) mounting the amplifier with screws and washers 110; (3) connecting wires to a power source 120; (4) connecting the ground wires 130; (5) connecting the remote wire 140; (6) connecting the audio jacks 150; (7) connecting the amplifier to the car's speakers and/or subwoofer 160, 170; (8) connecting the speakers 180; (9) adjusting the amplifier settings 190; and (10) troubleshooting the amplifier 200. As shown, these steps are laid out on two pages in column format with pictures of tasks and parts used and installation techniques, thus simplifying the installation process and ensuring proper installation while simultaneously minimizing the likelihood of the corresponding product being damaged during installation and/or returned to the merchant.

FIG. 2 shows another example of the present invention. The method and system are used for installing a subwoofer in a vehicle and the instructions are laid out graphically and textually in four steps. These steps include: (1) unpacking the product's contents and laying out if necessary 210; (2) mounting the subwoofer in a vehicle 220; (3) installing the subwoofer by connecting the necessary audio cable(s); and (4) troubleshooting the subwoofer 240.

Although these embodiments all contain numbered steps, the steps need not be numbered. For example, if columns are used, users know to read from left to right and top to bottom. This means that if columns are used, the steps may begin on the left or upper left side of a page in one column, proceed downward in the column and then proceed to the beginning of the next column to the right of the completed column. Alternatively, if columns are not used, arrows may be used to direct the user's attention to the step(s) that need to be completed next. Alternatively, columns may not be used. Instead, the instructions appear on multiple pages or sheets with each page or sheet providing at least one installation instruction.

The steps shown herein are by way of example and manufacturers may vary the steps or their number for the different products installed. Additionally, the troubleshooting step is optional and need not appear with the textual and graphical instructions.

The present invention may be embodied in other specific forms without departing from the spirit or essential attributes thereof and, accordingly, reference should be made to the appended claims, rather than to the foregoing specification, as indicating the scope of the invention.

1. A method of providing instructions for installing an audio or electrical product comprising utilizing textual and graphical representations.

2. The method of claim 1, wherein the textual and graphical representations are laid out in a sequential, logical order.

3. The method of claim 1, wherein the instructions comprise a schematic.

4. The method of claim 1, wherein in the audio or electrical product is for an automobile.

5. A system for installing an audio or electrical product comprising an instruction sheet or manual containing textual and graphical instructions.

6. The system of claim 5, wherein the instructions comprise numbered steps.

7. The system of claim 5, wherein the audio or electrical component is for an automobile.
